(19) United States
(12) Patent Application Publication
(10) Pub. No.: US 2022/0294695 A1
(43) Pub. Date: Sep. 15, 2022

(54) Resource Efficient Cyclic Communication

(71) Applicant: Telefonaktiebolaget LM Ericsson (publ), Stockholm (SE)

(72) Inventors: Hubertus Munz, Aachen (DE); Norbert Reider, Tényö (HU); Geza Szabo, Kecskemét (HU); Sándor Rácz, Cegléd (HU)

(21) Appl. No.: 17/632,254

(22) PCT Filed: Aug. 7, 2019
(86) PCT No.: PCT/EP2019/071225

§ 371 Date: Feb. 2, 2022

(51) Int. Cl. H04L 41/08; H04L 41/044; H04W 28/08; H04W 56/00

(52) U.S. Cl. CPC H04L 41/0886; H04L 41/044; H04W 28/0908; H04W 56/001

(57) ABSTRACT

The invention relates to a method for operating an orchestration entity (100) configured to control a plurality of control entities (50-53), wherein each of the plurality of control entities controls a device (20-24) with control commands transmitted over a cellular network (70), the method comprising: —determining a number of active control entities (50-53), —determining a number of devices (20-24) controlled by each of the active control entities, —determining, for each of the active control entities, a command cycle between consecutive control commands transmitted by the corresponding control entity over the cellular network to each of the devices under its control, —determining, for each of the active control entities, at least one start time when the corresponding control entity (50-53) should start transmitting the control commands to each of the devices under its control, —transmitting the at least one start time to each of the control entities.

### TECHNICAL FIELD

The present application relates to a method for operating an orchestration entity configured to control a plurality of control entities. Furthermore, the corresponding orchestration entity is provided, a computer program and a carrier comprising the computer program.

### BACKGROUND

In control systems like used in factory automation it is common to use cyclic communication. A controller (which could be a Programmable logic Controller PLC) sends a command to a device (which could be a robot) and might await a feedback from the device as a reply, containing any kind of status information. This forms a basic control loop as shown in FIG. 1. The cycle time is defined as the time between two consecutive commands sent to a device from the controller. If the use cases are either safety-critical or are subject to certain accuracy requirements, the cycle time gets lower i.e. the two devices communicate more frequently.

The communication in industrial use cases is not restricted to two peers only. So, it is of course possible that a controller gives multiple commands to multiple devices within one cycle, or one device is controlled by multiple independent controllers. Furthermore, the communication can be more or less complex than the two-way transmission illustrated in FIG. 1. Sometimes the communication has its own cycle time that is independent from the cycle time of the controller or the devices.

A maximum latency is defined as a deadline, usually within each cycle until the communication needs to be happened correctly. Depending upon the strictness of the application, deadline violations are allowed to a certain extent, so for example once is fine, but never in consecutive cycles or similar. In general, the deadline is something the communication system should respect and clearly constrains the communication system design. Therefore, a queuing of packets in the communication network is in general undesired as it leads to additional latencies.

In a control setting the controller is the cycle master. Communication can either be happening in a synchronous or asynchronous manner, so the devices could all be aware of the cycle timing or just the controller.

### Examples

Profinet is an industrial communication protocol and is based on synchronization between all peers by using PTP (Precision Time Protocol). A controller that uses Profinet to communicate to devices communicates in a synchronized manner. The devices can therefore be aware about cycle times.
Some Industrial Applications are simply polling based to avoid the need for synchronization; a device just reacts on a polling message it gets from the controller without being aware about any cycle times etc., after receiving the polling message the device replies for example with a status message or similar.

In any case the controller keeps an eye on the deadline and initiates actions in the case the deadline is violated once or consecutive times depending on the implementation. A potential action is a shutdown of the device to avoid safety issues.

Usually the absolute timing of cycle times is irrelevant, that means it is not relevant if a cycle x starts at a certain point in time t1 (for example at 12:15 PM) and the next cycle x+1 at a time t2 (12:15 PM+1*cycle time), but instead the absolute timings doesn't matter at all, as long as the time between t1 and t2 is precise, i.e. the cycle time.

In today's factory automation scenarios, many distributed controllers are deployed in a factory. Usually one controller is used for one automation cell, taking care for a small group of devices.

Within each cycle there are as well times where no communication is ongoing, or at least no critical communication, i.e. communication that is observed by the controller and including a communication deadline. Assuming no violation is happening, this empty time, where no traffic is ongoing, is allocated between the deadline and the next cycle start.

In future factories enabled using technologies like 5G and TSN (Time Sensitive Networking), it is envisioned that controllers might be virtualized and then deployed rather centrally for example in a cloud environment. This will increase the importance of a reliable communication infrastructure, especially, when the wireline communication medium between the cloud environment and devices is switched to wireless.

In general, introducing wireless connection in factory automation increases the flexibility by a large extent. This also means that one needs to consider the less favorable characteristics of wireless technologies. Namely, that the performance of such systems is limited compared to the wireline technologies. Since radio is always a scarce resource, it is desirable to consider its capacity and utilization and try to optimize them in any case.

Ultra-Reliable Low-Latency Communication (URLLC) in 5G radio is supported through a URLLC-toolbox. In common these tools require more spectral resources if the targeted latency gets lower. The number of URLLC connections that can be served assuming a given carrier bandwidth is a very important KPI for mobile networks especially for factory automation use cases, where it is typically not about maximizing the throughput in general as the traffic characteristics are fixed as explained above

Wireless communication is always resource constrained as it is a broadcast medium. The existing radio resources are shared between multiple links, so for example between several controllers and devices.

In a worst case, multiple uncoordinated controllers that communicate using the same radio resources choose a cycle timing that is exactly overlapping, which means that the involved deadlines as well as communication patterns are overlapping as well. This state is very uncomfortable as it puts a high pressure on the radio resources to not violate all deadlines. This creates a bottleneck and limits the number of devices that can be connected to the network assuming a radio resource limitation. This state is illustrated in FIG. 2, assuming the same cycle times for n controllers/PLCs. The blocks 10 illustrate the time until the deadline arrives in each cycle. The bandwidth requirements are assumed to be equal for all PLCs. It becomes clear that the bandwidth usage is not balanced, and the peak usage defines the maximum number of how many controllers can be connected.

### SUMMARY

Accordingly, a need exists to overcome the above described problems and to more equally balance the bandwidth usage in a system where a plurality of control entities control at least one device with control commands transmitted over a cellular network.

This need is met by the features of the independent claims. Further aspects are described in the dependent claims.

According to a first aspect a method for operating an orchestration entity is provided configured to control a plurality of control entities, wherein each of the plurality of control entities controls a device with control commands transmitted over a cellular network. According to the method the orchestration entity determines a number of active control entities and the number of devices controlled by each of the active control entities. Furthermore, for each of the active control entities, a command cycle is determined between consecutive control commands transmitted by the corresponding control entity over the cellular network to each of the devices under its control. Furthermore, at least one start time is determined for each of the active control entities when the corresponding control entity should start transmitting the control commands to each of the devices under its control. Furthermore, the at least one start time is transmitted to each of the control entities.

According to the application a central coordination is carried out by the orchestration entity which orchestrates the command cycles of the different control entities such that the traffic of the cycle communication is balanced and distributed. Different pieces of information are collected by the orchestration entity and the optimal start times are determined for the control entities and transmitted to the control entities.

Furthermore, the corresponding orchestration entity is provided comprising at least one processing unit and a memory wherein the memory contains instructions executable by the at least one processing unit. The orchestration entity is operative to work as discussed above or as discussed in further detail below.

As an alternative an orchestration entity is provided configured to control a plurality of control entities wherein each of the plurality of control entities is configured to control a device with control commands transmitted over the cellular network. The orchestration entity can comprise a first module configured to determine the number of active control entities. A second module of the entity is configured to determine a number of devices controlled by each of the active control entities and a third module is provided configured to determine for each of the active control entities the command cycle between consecutive control commands. A fourth module is provided configured to determine, for each of the active control entities, at least one start time when the corresponding control entity should start transmitting the control commands to each of the devices under its control. A fifth module of the orchestration entity is provided configured to transmit the at least one start time to each of the control entities.

Furthermore, a computer program comprising program code is provided, wherein execution of the program code causes the at least one processing unit to execute a method as discussed above or as explained in further detail below. Additionally a carrier comprising the computer program is provided, wherein the carrier is one of an electronic signal optical signal, radio signal, or computer readable storage medium.

It is to be understood that the features mentioned above in features yet to be explained below can be used not only in their respective combinations indicated, but also in other combinations or in isolation without departing from the scope of the present invention. Features of the above mentioned aspects and embodiments described below may be combined with each other in other embodiments unless explicitly mentioned otherwise.

### BRIEF DESCRIPTION OF THE DRAWINGS

The foregoing and additional features and effects of the application will become apparent from the following detailed description when read in conjunction with the accompanying drawings in which like reference numerals refer to like elements.

FIG. 1 shows a schematic view of an example cyclic communication between a device and its control entity as known in the art.

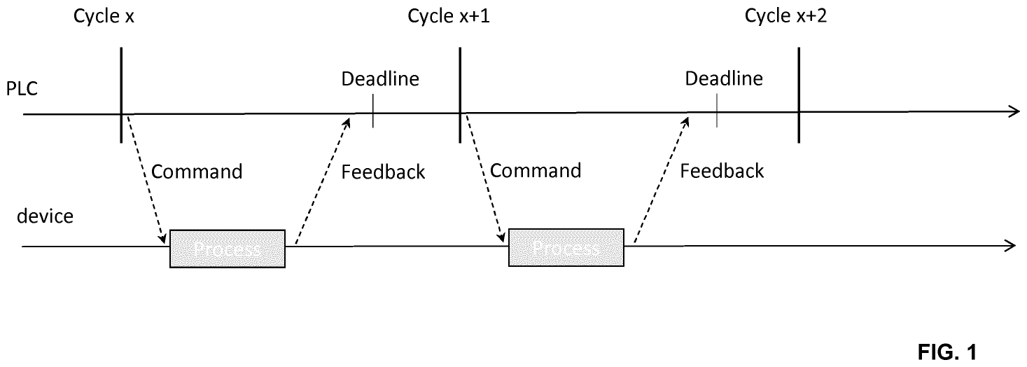

FIG. 2 shows an example schematic view of the alignment of the command cycles in a worst-case scenario in which all cycle time start at the same time.

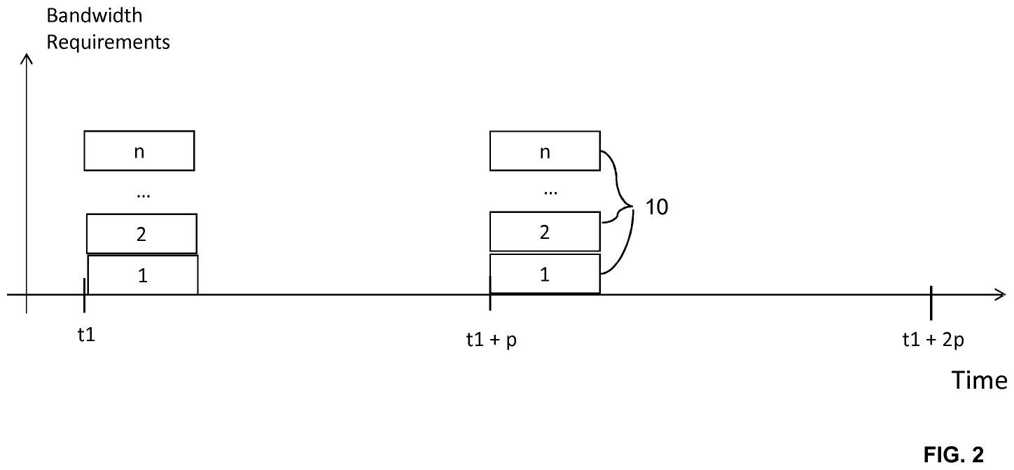

FIG. 3 shows an example schematic architectural overview over a system in which an orchestration entity distributes the cycle times of different control entities which control the different devices over a cellular network.

FIG. 4 shows an example schematic view of a distribution of the different command cycles over time where all the command cycles start at different points in time.

FIG. 5 shows an example schematic view of a flowchart comprising the steps carried out by the orchestration entity when controlling the start times of this command cycles for the different control entities shown in FIG. 3.

FIG. 7 shows another schematic view of a flowchart comprising the steps carried out by the orchestration entity shown in FIG. 3.

FIG. 8 shows an example schematic representation of the orchestration entity configured to distribute the start times of the command cycles over time.

FIG. 9 shows another example schematic representation of the orchestration entity as shown in FIG. 3.

### DETAILED DESCRIPTION

In the following, embodiments of the invention will be described in detail with reference to the accompanying drawings. It is to be understood that the following description of embodiments is not to be taken in a limiting sense. The scope of the invention is not intended to be limited by the embodiments described hereinafter or by the drawings, which are to be illustrative only.

The drawings are to be regarded as being schematic representations, and elements illustrated in the drawings are not necessarily shown to scale. Rather, the various elements are represented such that their function and general purpose becomes apparent to a person skilled in the art. Any connection or coupling between functional blocks, devices, components of physical or functional units shown in the drawings and described hereinafter may also be implemented by an indirect connection or coupling. A coupling between components may be established over a wired or wireless connection. Functional blocks may be implemented in hardware, software, firmware, or a combination thereof.

As will be discussed below, a central coordination entity, orchestration entity called hereinafter is proposed that orchestrates multiple control loops occurring between control entities and the corresponding devices such that the traffic of the cyclic communication of the multiple control entities is balanced in time so that the load on the wireless communication medium is decreased significantly or minimized. With the wireless communication medium the proposed solution is beneficial as the radio spectrum is always a limited resource and careful optimization of the its usage is important.

As will be discussed below several pieces of information are collected from a system such as an industrial automation system which comprises the different control entities and the devices are connected over a wireless network, and the orchestration entity calculates the optimal start times of all the control entities. The control entities can then use the configured settings during their whole operation.

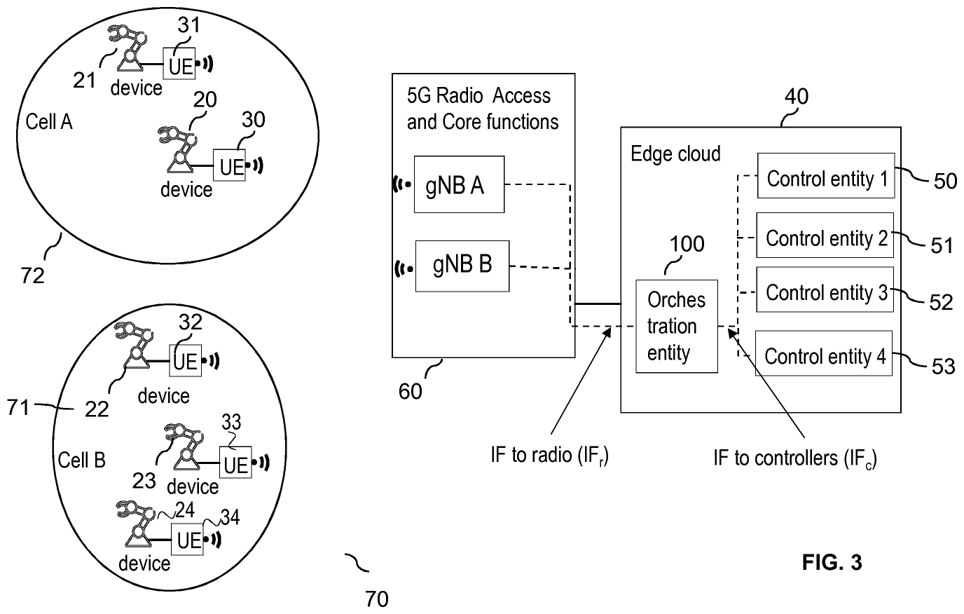

FIG. 3 shows a schematic overview over such a system in which the orchestration entity 100 is connected to different control entities 50, 51, 52, and 53. The orchestration entity has a first interface IF_{c} to the control entities and another interface (IFᵣ) to a cellular network 70 here the radio base stations implemented in a 5G network.

Different control entities 50 to 53 control different devices 20 to 24 wherein each of the devices is connected to a corresponding user equipment 30 to 34.

Within the context of the present application the term user equipment, UE, refers to a device which is associated with non-humans like machines, animals or plans. The UE may also refer to device for instance used by a person used for his or her personal communication. It may be a telephone type of device, cellular telephone, mobile station, cordless phone, or a personal digital assistant type of device like laptop, notebook, notepad, tablet equipped with a wireless data communication. Each of the UEs 30 to 34 may be equipped with a Subscriber Identity Module, SIM, comprising unique identities such as the International Mobile Subscriber Identity, IMSI, the Temporary Mobile Subscriber Identity, TMSI, or the Globally Unique Temporary UE Identity, GUTI, associated with the user using the UE. The presence of the SIM within the UE customizes the UE uniquely with a subscription. For the sake of clarity, it is noted that there is a difference but also tight connection between a user and a subscriber. The user gets access to the network by acquiring a subscription to the network and by that becomes a subscriber within the network. The network then recognizes the subscriber based on the IMSI, TMSI or GUTI or the like and uses the associated subscription to identify related subscription data. The user is the actual user of the UE, or maybe also the one owing the subscription.

The orchestration entity 100 and the different control entities 50 to 53 can be located in a cloud environment or edge 40. The cellular network is implemented as a 5G network in the example shown, however it should be understood that it may also be a 4G or any other cellular network, wherein the cellular network comprises the different cells such as the cells 71 and 72 as shown. The orchestration entity 100 can collect with the different interfaces shown in FIG. 3 towards the radio access network 60 and towards the control entities the following elements:
the list of active control entities,
the command cycle, i. e. the control cycle times of the active controllers,
the list of active devices per active controller,
the list of active devices that belongs to a specific radio cell 71 or 72, and
the load of each radio cell 71, 72.

Based on the different collected command cycles the orchestration entity 100 tries to evenly distribute the transmitted data.

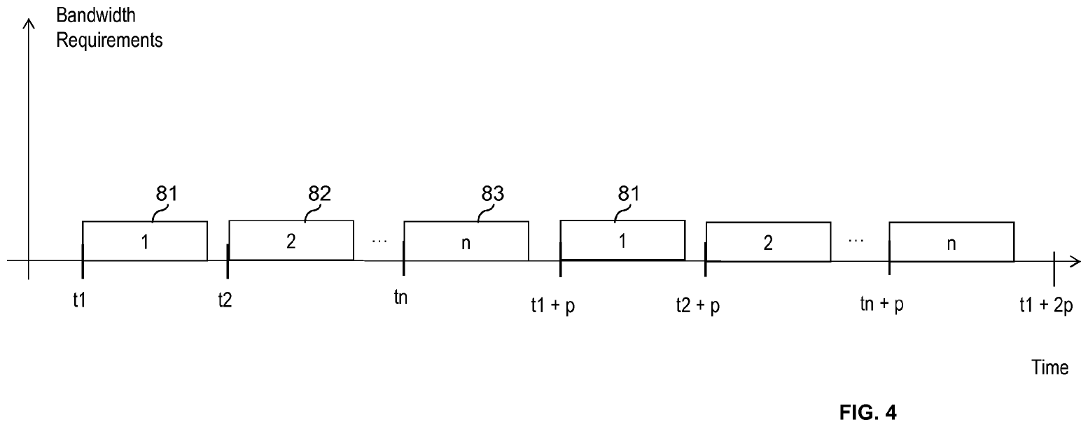

As shown in FIG. 4 n command cycles are distributed over time wherein all the n cycle times have the same periodicity p. A first control entity uses start time t1 to transmit the data in block 81, a second of the control entities transmits the data in block 82 so that the n blocks 81 to 83 are transmitted within the p.

The orchestration entity tries to avoid the overlapping of the communication packets between different control entities and devices as much as possible to decrease the instantaneous radio resource needs of the system. Accordingly, the orchestration entity 100 is responsible to align the cycle times of all control entities that control devices connected to the same radio cell. By a radio cell a geographic area is meant where devices are connected to the same radio access node in the 3GPP terminology, in FIG. 3 the same gNB. The orchestration entity can be implemented as cycle timing orchestrator, CTO.

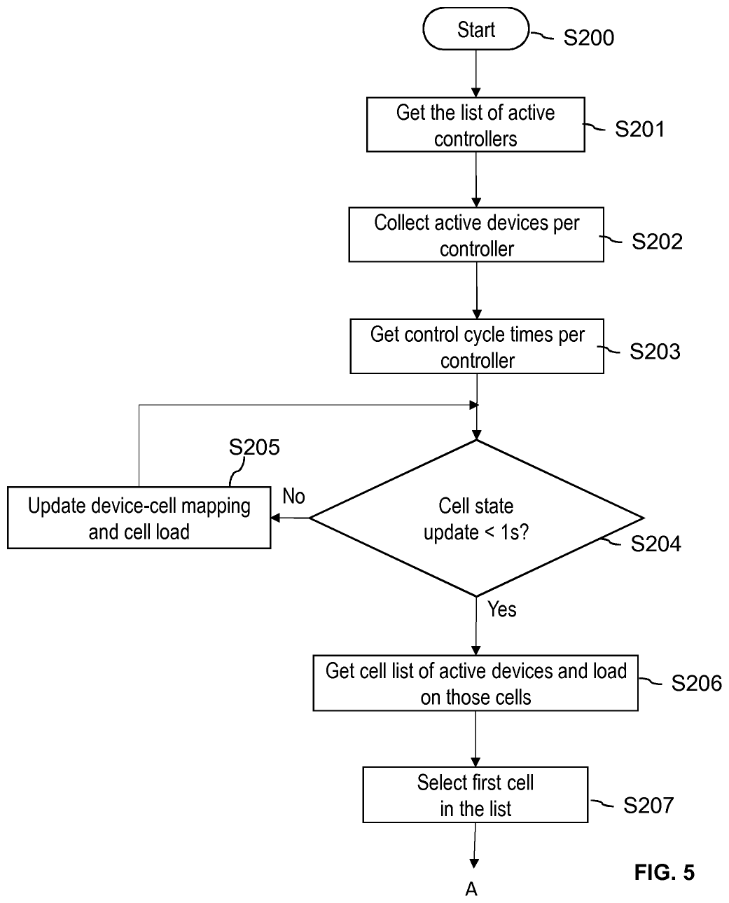

FIGS. 5 and 6 show a possible implementation. In this implementation it is assumed that the system time is common inside the edge cloud so that the cloud components are time synchronized. The method starts in S200 and as shown in connection with FIG. 3 the orchestration entity 100 has two interfaces, one needed to collect the radio related information, the other one is used towards the virtual control entities running in the edge cloud 40. In step S201 the list of active controllers is collected with the interface towards the cloud, IF_{c}. Each control entity sends its identity and the control cycle time p to the orchestration entity 100. Furthermore, the device identities that they control are sent to the orchestration entity 100. Accordingly, in step S202 the number of active devices per controller is collected and determined. As shown in FIG. 3 it is assumed that one UE is assumed to belong to one device 20 to 23. In such a case the mapping between the UEs and the devices is straightforward, using simply the same carts attached. In case that one control entity applies multiple control cycle times to different devices, then the different command cycles are handled as they would be applied by separate control entities. Accordingly, in step S203 the command cycles or cycle times per controller are determined.

Then the orchestration entity can collect information on the radio state, for instant, what the current radio cells of the devices are that belong to a certain control entity, and what load those radio cells carry at the moment. This information may change quickly over time due to hand overs and network traffic changes, thus they need to be updated regularly, by way of example every second. Accordingly, it is ask in step S204 whether a current cell radio state is available. If this is not the case, the information about the mapping of the devices to the cell and the cell load is updated in step S205. The corresponding interface towards the radio network IFᵣ can be the management interface available today, the O & M interface or other interfaces that connect directly to the radio access nodes to fetch a necessary information. By way of example in case of a 5G core network, the Network Exposure Function, NEF, features can be used for this purpose where this information can be easily obtained. Accordingly, in step S206 a list can be generated of the active devices and the load on the corresponding cells. Accordingly a list is available where the radio cells, their respective control entities and the corresponding active devices are present. By way of example one may create a nested list as follows:

Cell_1: Ctrl₁(Device₁, Device₈), Ctrl₄(Device₂, Device₃)

Cell_2: Ctrl₃(Device₉), Ctrl₆(Device₄, Device₆)

Cell_3: Ctrl₅(Device₇)

In step S207 a first cell in the list may be selected.

As indicated in FIG. 6 the method continues by obtaining the current system time t_{c} (S208). Now the orchestration entity is aware of the cycle times of the different active controllers, the different pᵢ values and the list can be sorted ascending in cycle times for a given cell so that it is possible to loop through the sorted list one by one. The sorting helps to start the allocation of cycle times over the radio link with the most frequent and the most critical control entity and devices (S209). When the first controller device pair is selected in step S210 it is checked whether the item exists (S211). It is then possible to calculate an absolute time stamp for each control entity that will be set as the starting time of the operation. The timestamp for control entity i denoted as tᵢ can be calculated as follows:

tᵢ=t_{c}+tₚ+f(i) (1)

Accordingly, the timestamp is calculated in step S212 wherein t_{c} is the current system time as mentioned above. Furthermore tₚ denotes a time constant that should be added to a later start time. This can mean some estimated processing and communication time towards the control entities so that the absolute time value will not end up before setting a timestamp that is already in the past. To distribute the cycle times over time, a function f(i) is used that returns an offset in the function of the control entity identity. The function can be defined by different ways according to different options wherein two options are given below:

f(i)=i*T_{g} (2)

f(i)=T_{g}(i) (3)

The function f(i) can return simply a constant time gap value T_{g} multiplied by the index as shown by equation 2 so that the same amount of time is waited before allocating the next start time of the cyclic operation of controller i. Furthermore, it is possible to set T_{g} as a function of the index as shown by equation 3 in case a gap time should be specifically set for each control entity. Here it is possible to take into account the actual network load one control entity creates, so if the control entity i sends significantly larger traffic over the network than the others the corresponding T_{g} (i) can be adapted accordingly, by way of example increased.

As shown by step S213 it is possible to introduce a time threshold Tₜₕ which can limit how far in time the different control entities for a cell should diverge. By way of example, if all the control entities should be started within 500 ms, the solution can then validate whether it's feasible with the current configuration. In case it is determined in step S213 that the difference of the calculated start time of control entity i and the current system time t_{c} is larger than the threshold Tₜₕ, it means that it is not possible to carry out the coordinated allocation of the cycle times for all devices. In step S214 the operator of the control entities and/or of the cellular network can be informed accordingly. If the threshold time is not exceeded the method continues in step S215. Accordingly the method continues to calculate the start time for the next control entity Tᵢ₊₁. If there are no more control entities in the list, it is possible to predict the load on the radio cell taking into account the freshly calculated timings Tᵢ and expected control package sizes per control entity. Accordingly, in step S216 the cell load can be predicted. Accordingly, it can be asked in step S217 whether the cell load exceeds a predefined limit. If the load of the radio cell is calculated to exceed a limit, the network operator may be notified in step S218 that the capacity of the radio cell may reach its limits so that a deteriorated performance for the respective control entities can be expected. In step S219 it is asked whether a further cell exists and if this is the case, the next cell is selected in step S220. If the calculation of the start times was carried out for all cells the corresponding start times are sent to the corresponding control entities (S221) where, in the example given N_{cltrs} denotes the total number of controllers in the system. The operation of the control entities shall start exactly at the provided timestamp or start times to avoid overlapping and in order to balance the load on the underlying radio network. The method ends in step S252.

The cell load can be considered when a new connection needs to be established from one or more control entities to one or more devices connected to one or more cells. The traffic exchange between the control entities and the devices, especially industrial traffic is predictable due to its predictable traffic patterns, which allows for an accurate planning of the required network resource needs. A device can be considered as static or mobile, in the latter case handovers to other cells and therefore a transition of loads from one cell to another can be considered. For this reason a periodic re-coordination of the links as introduced or calculated above may be necessary. The cell load in the present context is especially the amount of critical and potentially cyclic traffic a cell has to carry. A traffic is considered as time critical when it has to arrive at its destination within a certain period such as 10 or 20 ms. For instance, the motion control commands of a robot arm are considered as time critical since packets need to arrive to the servo motors within e.g., 20 ms. Another example of time critical traffic can be the traffic of the safety functions that needs to arrive to the destination in e.g., 10 ms.

Any non-time critical traffic without strict quality of service, QS requirements or at least noncritical for the production process is not necessarily considered as it can always be contested or rejected while critical traffic is prioritized in another embodiment non time critical traffic is also considered.

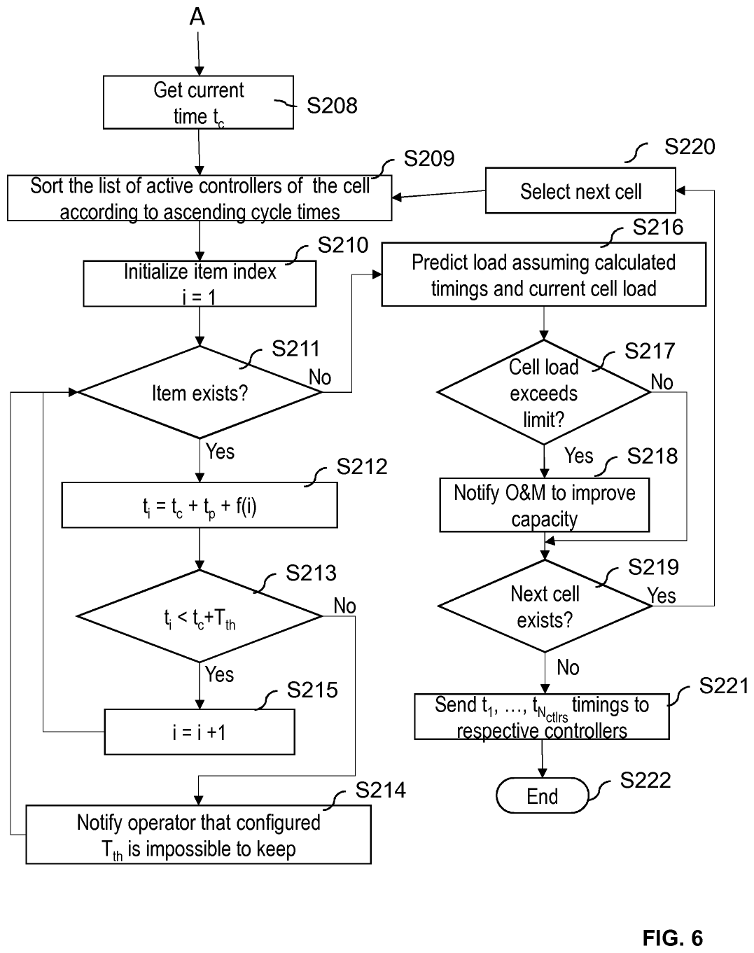

FIG. 7 summarizes some of the steps carried out by the orchestration entity 100. In step S230 the number of active control elements is determined by the orchestration entity. Furthermore, at least the number of devices that is controlled by each of the control entities is determined in step S231. Furthermore, in step S232 the command cycle is determined for each of the communication connections between a corresponding control entity and a device. Based on the determined information it is possible to determine for each of the active control entities the start times when the corresponding control entity should start the transmission of the control commands to each of the devices under its control. In step S234 the start times can then be transmitted to each of the control entities for each communication channel to a corresponding device.

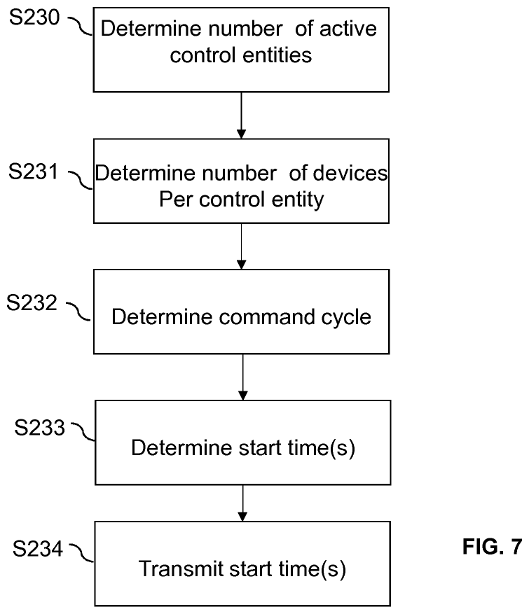

FIG. 8 shows a schematic view of the orchestration entity 100 which can carry out the above discussed steps of the orchestration of the start times. The entity 100 comprises an interface or input/output 110 which is provided for transmitting user data or control message to other entities or for receiving user data and control messages from other entities. The interface may be implemented as interface between the orchestration entity and the different control entities. This interface IF_{c} can send the information to the control entities such as the timestamp when the cyclic data transfer can be started. Furthermore, it can transmit the request message such as a broadcast message to get the identities of the different control entities with the corresponding device identities and the cycle times. The interface may receive information such as the control entity identity and the device identities that are under control of a single control entity. The interface may be implemented as a further interface between the orchestration entity and the radio network, IFᵣ. This interface may transmit to the radio network the request message to send the cell IDs and the load information. Furthermore, the interface may receive from the radio network to cell ID of a given device, the load measure for giving cell and the device IDs that are under control of the control entity.

The entity 100 furthermore comprises a processing unit 120 which is responsible for the operation of the entity. The processing unit 120 comprises one or more processors and can carry out instructions stored in memory 130, wherein the memory may include a read-only memory, a random access memory, a mass storage, a hard disk or the like. The memory can include suitable program code to be executed by the processing unit 120 so as to implement the above described functionalities in which the orchestration entity is involved.

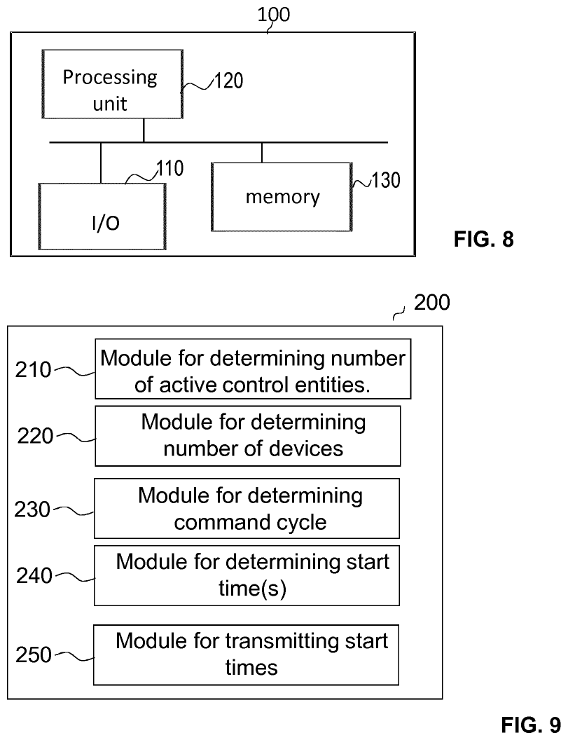

As an alternative the orchestration entity 200 can be provided as shown in FIG. 9. The orchestration entity can comprise a first module 210 configured to determine the number of active control entities. A further module 220 can be provided for determining the number of devices controlled by each of the active control entities. A third module 230 can be provided configured to determine the command cycle. A module 240 can be configured to determine the start times for the different communication channels between the control entities and the devices and module 250 can be provided configured to transmit the start times to the corresponding devices.

The radio interface may be configured such that notification in the radio network are transmitted to the orchestration entity so that the latter receives updates on the fact when a device executes a hand over to another cell or when the cell load significantly changes.

In the examples given above a situation was based on the assumption that we have a synchronized time for all the control entities and devices. In case there is no time synchronization, it is also possible to apply the solution, but instead of sending the start times to the control entities, to control entity can wait until the calculated start time or timestamp is reached. It may take into account further communication delays, however they could be negligible in an edge cloud and maybe below 10 μs. The corresponding control entity can then react immediately so that the command from the orchestra entity directly triggers the start of the command cycle.

Another option on the interface 110 to the control entities is that the control entities register themselves with the necessary information at start up at the orchestration entity 100, so that there is no need to send request messages from the orchestration entity 100. This mechanism may be preferable when there is an existing registering process already used by the control entities 50-53, since then they can remain unchanged, and only the register messages need to be received and processed by the orchestration entity 100. This mechanism may be preferred when there is an existing registering process already used by the control entities since then they can remain unchanged, only directions messages which have to be received and processed by the orchestration entity.

From the above set some general conclusions can be drawn: (here we summarize the dependent claims)

It is possible to determine the number of devices for each cell of the cellular network and the at least one start time is determine per cell taking into account the number of devices per cell.

As discussed above in connection with FIGS. 5 and 6 the start times are calculated per cell.

Furthermore, it is possible to determine a traffic load per cell wherein the at least one start time is determined per cell taking into account the traffic load for each of the cells.

The at least one start time can be determined for each of the active control entities on a per cell basis of the cellular network, and the corresponding at least one start time can be transmitted to each of the control entities of the cell after all the start times for at least one cell have been calculated. As discussed in connection with FIG. 6 the start times can be calculated when the calculation has been finished for all cells.

The at least one start time can be determined based on a synchronized system time t_{c} which is valid for all the active devices and the orchestration entity 100 wherein a control entity dependent time offset can be used after which the corresponding control entity should start transmitting its control commands.

Furthermore, it is possible that the at least one start time is determined, for each of the active control entities by adding a fixed time constant tₚ to the synchronized system time and to the control entity dependent time offset. This fixed time constant tₚ can make sure that no time value is set which is already in the past due to the needed processing time.

In the assumption above a synchronized time was used. However, it is also possible that the at least one start time is determined for each of the active control entities on a per cell basis, wherein the at least one start time is transmitted, for each of the control entities, to the corresponding control entity at the at least one start time as determined for the corresponding control entity. In this embodiment the control entity can then react immediately based on the received start time which acts as a trigger to directly transmit the required commands.

Furthermore it is possible that the at least one start time for each of the active control entities is determined such that the at least one start time for each of the active control entities is distributed within a threshold. Tₜₕ such that a number of overlapping start times within the threshold period is minimized. Furthermore, it is possible that it is determined whether the at least one start time of all active control entities can lie within the threshold period Tₜₕ. If this is not the case, the operator may be notified as discussed in connections FIG. 6 steps S213 to step S214.

The number of active control entities, the number of devices controlled by each of the active control entities and the command cycle and the at least one start time may be determined for each of the active control entities with a periodicity p.

As the devices 20 to 23 or the control entities 50 to 53 may be moving the number of active control entities and the number of devices per control entity can vary.

Furthermore, the orchestration entity can determine whenever one of the devices was handed over from one cell to another cell by receiving a responding information from the cellular network and a traffic load is determined on a cell basis again when this information is received.

Furthermore, it is possible to determine a data traffic load in the cellular network on a cell basis when the at least one start time has been determined for each of the active control entities in the corresponding cell. If it is determined that the data traffic load is higher than a traffic threshold, an operator of the cellular network may be informed accordingly.

The above discussed solution balances the utilization of the radio network part and thus decreases the number of radio cells needed to serve a given load on the network in an environment with many control entities and the corresponding devices controlled by the control entities via the cellular network.

1.-46. (canceled)

47. A method for operating an orchestration entity configured to control a plurality of control entities, wherein each of the plurality of control entities controls a device with control commands transmitted over a cellular network, the method comprising:
determining, for each active control entity, a command cycle between consecutive control commands transmitted by the active control entity over the cellular network to the device under control of the active control entity;
determining, for each active control entity, a start time when the active control entity should start transmitting the control commands to the device under control of the active control entity; and
transmitting, to each active control entity, the start time determined for that active control entity.

48. The method according to claim 47, further comprising determining a number of devices per cell of the cellular network, wherein the start time is determined for each active control entity on a per cell basis taking into account the number of devices per cell.

49. The method according to claim 47, further comprising determining a traffic load per cell of the cellular network, wherein the start time is determined for each active control entity on a per cell basis taking into account the traffic load per cell.

50. The method according to claim 47, wherein the start time is determined for each active control entity on a per cell basis of the cellular network, wherein the start times respectively determined for the active control entities are transmitted after all the start times for at least one cell have been calculated.

51. The method according to claim 50, wherein the one start time is determined for each active control entity based on:
a synchronized system time valid for all active control entities and the orchestration entity; and
a control entity dependent time offset after which the corresponding control entity should start transmitting its control commands.

52. The method according to claim 51, wherein the start time is determined, for each active control entity, by adding a fixed time constant to the synchronized system time and to the control entity dependent time offset.

53. The method according to claim 47, wherein the start time is determined for each active control entity on a per cell basis of the cellular network, wherein, for each active control entity, the start time determined for that active control entity is transmitted to the active control entity at the start time determined for the active control entity.

54. The method according to claim 47, wherein the start time for each active control entity is determined such that the start time for each active control entity is distributed within a threshold period such that a number of overlapping start times within the threshold period is minimized.

55. The method according to claim 54, further comprising determining whether the start times of all active control entities can lie within the threshold period, wherein if this is not the case, an operator of the control devices is informed accordingly.

56. The method according to claim 47, wherein a number of active control entities, a number of devices controlled by each active control entity, the command cycle for each active control entity, and the start time for each active control entity is determined with a periodicity t.

57. The method according to claim 49, wherein whenever one of the devices was handed over from one cell to another a corresponding information is received and a cell traffic load is determined on a cell basis.

58. The method according to claim 47, further comprising determining a data traffic load in the cellular network on a cell basis when the start time has been determined for each active control entity in the corresponding cell, wherein if the determined data traffic load is higher than a traffic threshold, an operator of the cellular network is informed accordingly.

59. An orchestration entity configured to control a plurality of control entities, wherein each of the plurality of control entities is configured to control a device with control commands transmitted over a cellular network, wherein the orchestration entity comprises at least one processing unit and a memory, the memory containing instructions executable by said at least one processing unit, wherein the orchestration entity is operative to:
determine, for each active control entity, a command cycle between consecutive control commands transmitted by the active control entity over the cellular network to the device under control of the active control entity;
determine, for each active control entity, a start time when the active control entity should start transmitting the control commands to the device under control of the active control entity; and
transmit, to each active control entity, the start time determined for that active control entity.

60. The orchestration entity according to claim 59, further being operative to determine a number of devices per cell of the cellular network, and to determine the start time for each active control entity on a per cell basis taking into account the number of devices per cell.

61. The orchestration entity according to claim 59, further being operative to determine a traffic load per cell of the cellular network and to determine the start time for each active control entity on a per cell basis taking into account the traffic load per cell.

62. The orchestration entity according to claim 59, further being configured to determine the start time for each active control entity on a per cell basis of the cellular network, Wherein the orchestration entity is configured to transmit the start times respectively determined for the active control entities after all the start times for at least one cell have been calculated.

63. The orchestration entity according to claim 62, further being operative to determine the start time for each active control entity based on:
a synchronized system time valid for all active control entities and the orchestration entity; and
a control entity dependent time offset after which the corresponding control entity should start transmitting its control commands.

64. The orchestration entity according to claim 63, further being operative to determine the start time for each active control entity by adding a fixed time constant to the synchronized system time and to the control entity dependent time offset.

65. The orchestration entity according to claim 59, further being operative to determine the start time for each active control entity on a per cell basis of the cellular network, and to transmit the start time determined for each active control entity to the active control entity at the start time determined for the active control entity.

66. The orchestration entity according to claim 59, further being operative to determine the start time for each active control entity such that the start time for each active control entity is distributed within a threshold period such that a number of overlapping start times within the threshold period is minimized.
